(19) United States
(12) Patent Application Publication
(10) Pub. No.: US 2013/0300340 A1
(43) Pub. Date: Nov. 14, 2013

(54) ARRANGEMENT AND METHOD FOR RECHARGING A RECHARGEABLE BACKUP BATTERY

(71) Applicant: Matt C. VIDETICH, Farmington Hills, MI (US)

(72) Inventor: Matt C. VIDETICH, Farmington Hills, MI (US)

(73) Assignee: GENERAL MOTORS LLC, DETROIT, MI (US)

(21) Appl. No.: 13/467,566

(22) Filed: May 9, 2012

(51) Int. Cl. H01M 10/46

(52) U.S. Cl. 320/101

(57) ABSTRACT

An arrangement for recharging a rechargeable backup battery of a telematics unit associated with a vehicle is disclosed herein. The arrangement includes, but is not limited to, an electrical device electrically coupled with the rechargeable backup battery. The electrical device is configured to convert light energy into electricity. The arrangement further includes a charge controller that is configured to direct an electric current from the electrical device into the rechargeable backup battery to recharge the rechargeable backup battery when the vehicle is in an off state.

### TECHNICAL FIELD

The technical field generally relates to vehicles, and more particularly relates to an arrangement for recharging a rechargeable backup battery of a telematics unit associated with a vehicle, a telematics unit for use with a vehicle, and a method of recharging a rechargeable backup battery of a telematics unit of a vehicle.

### BACKGROUND

Telematics units are electronic devices that are mounted to vehicles and that are compatible for use with communication systems that are used by telematics service providers to provide vehicle owners and operators with telematics services. Telematics services commonly include, but are not limited to, emergency response services. Emergency response services include establishing voice communication with a vehicle occupant(s) after a collision and telephonically connecting the vehicle occupant(s) with emergency service providers such as police and emergency medical service providers after a collision or other emergency event.

In a known example, telematics units are electrically connected to, and draw electric power from, the vehicle's battery. In the event of some emergency events, the electrical connection between the vehicle's battery and the telematics unit may be severed or otherwise disrupted. To account for this possibility, in a known example, a telematics unit may be equipped with a rechargeable backup battery. The telematics unit is configured to draw electric power from the rechargeable backup battery when a loss of electric power from the vehicle's battery is detected. This configuration ensures access to emergency services when they are needed.

In a known example, the telematics unit may be equipped with a recharging controller that is configured to control the recharging of the rechargeable backup battery using the vehicle's alternator. When the charging controller detects that the vehicle is in an on state, the recharging controller enables an electric current to flow from the alternator to the terminals of the rechargeable backup battery. When the vehicle is in an off state, the recharging controller inhibits recharging of the rechargeable backup battery so as to avoid draining the vehicle's battery. Thus, during periods when the vehicle is in an off state, the rechargeable backup battery is not recharged and may begin to discharge.

Accordingly, it is desirable to provide an arrangement that recharges the rechargeable backup battery during periods when the vehicle is in an off state. In addition, it is desirable to provide a telematics unit that is configured to recharge its rechargeable backup battery while the vehicle is in an off state. Also, it is desirable to provide a method for recharging a rechargeable backup battery of a telematics unit while the vehicle is in an off state. Furthermore, other desirable features and characteristics of the present invention will become apparent from the subsequent detailed description and the appended claims, taken in conjunction with the accompanying drawings and the foregoing technical field and background.

### SUMMARY

An arrangement for recharging a rechargeable backup battery of a telematics unit, a telematics unit, and a method of recharging a rechargeable backup battery are disclosed herein.

In a first non-limiting example, the arrangement includes, but is not limited to, an electrical device that is electrically coupled with the rechargeable backup battery. The electrical device is configured to convert light energy into electricity. The arrangement further includes, but is not limited to, a charge controller that is configured to direct an electric current from the electrical device into the rechargeable backup battery to recharge the rechargeable backup battery when the vehicle is in an off state.

In another non-limiting example, the telematics unit includes, but is not limited to, a housing. The telematics unit further includes, but is not limited to a rechargeable backup battery disposed within the housing. The telematics unit further includes a primary charge controller that is disposed within the housing and that is configured to direct a first electric current from a primary electric power source into the rechargeable backup battery when the vehicle is in an on state. The telematics unit further includes an electrical device that is associated with the housing. The electrical device is electrically coupled with the rechargeable backup battery and is configured to convert light energy into electricity. The telematics unit still further includes, but is not limited to a secondary charge controller that is configured to direct a second electric current from the electrical device into the rechargeable backup battery to recharge the rechargeable backup battery when the vehicle is in an off state.

In another non-limiting example, the method includes, but is not limited to detecting, with a charging controller, that the vehicle is in an off state. The method further includes, but is not limited to, directing, with the charging controller, an electric current from an electrical device that is configured to convert light energy into electrical energy to the rechargeable backup battery when the charging controller detects that the vehicle is in the off state.

### DESCRIPTION OF THE DRAWINGS

The exemplary embodiments will hereinafter be described in conjunction with the following drawing figures, wherein like numerals denote like elements, and wherein:

FIG. 1 is a schematic view illustrating a non-limiting example of a telematics service system that is compatible for use with a telematics unit as disclosed herein;

FIG. 2 is a schematic view illustrating a non-limiting example of an arrangement for recharging a rechargeable backup battery of a telematics unit;

FIG. 3 is a perspective view illustrating a non-limiting example of a telematics unit including an integrated solar panel for recharging a rechargeable backup battery;

FIG. 4 is a perspective view illustrating a non-limiting example of a telematics unit and a separate solar panel for recharging a rechargeable backup battery; and

FIG. 5 is a block diagram illustrating a non-limiting example of a method for recharging a rechargeable backup battery of a telematics unit.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

An arrangement and method for recharging a rechargeable backup battery of a telematics unit is disclosed herein. In an example, a telematics unit is fitted with a secondary charging controller and a solar panel. The secondary charging controller is configured to detect when the vehicle is in an off state and is further configured to direct an electric current from the solar panel into the rechargeable backup battery. The flow of the electric current from the solar panel into the rechargeable backup recharges the rechargeable backup battery. When the secondary charger detects that the vehicle is in an on state, the secondary charging controller will inhibit further recharging of the rechargeable backup battery by the solar panel.

A greater understanding of the examples of the arrangement and method for recharging a rechargeable backup battery of a telematics unit as disclosed herein may be obtained through a review of the illustrations accompanying this application together with a review of the detailed description that follows.

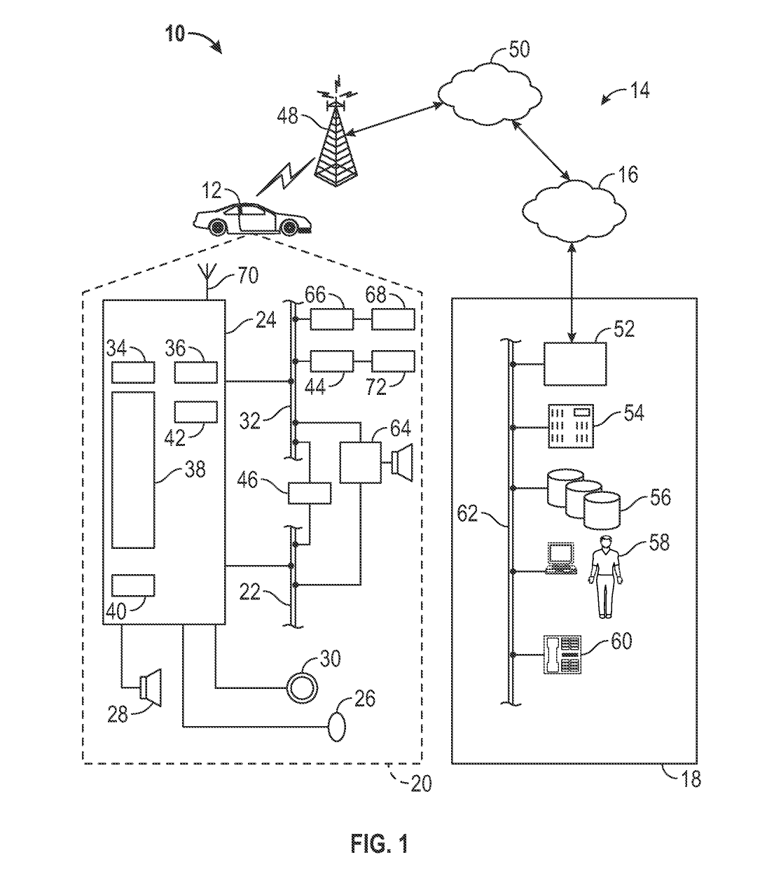

A general discussion of telematics service systems and telematics units is provided in the following paragraphs relating to FIG. 1.

With reference to FIG. 1, there is shown a non-limiting example of a communication system 10 that may be used together with examples of the aftermarket module arrangement disclosed herein or to implement examples of the method of communicating with a vehicle bus disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the method disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more components of vehicle hardware 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision sensor interface modules 66 is operatively connected to the vehicle bus 32. The collision sensors 68 provide information to the telematics unit via the crash and/or collision sensor interface modules 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

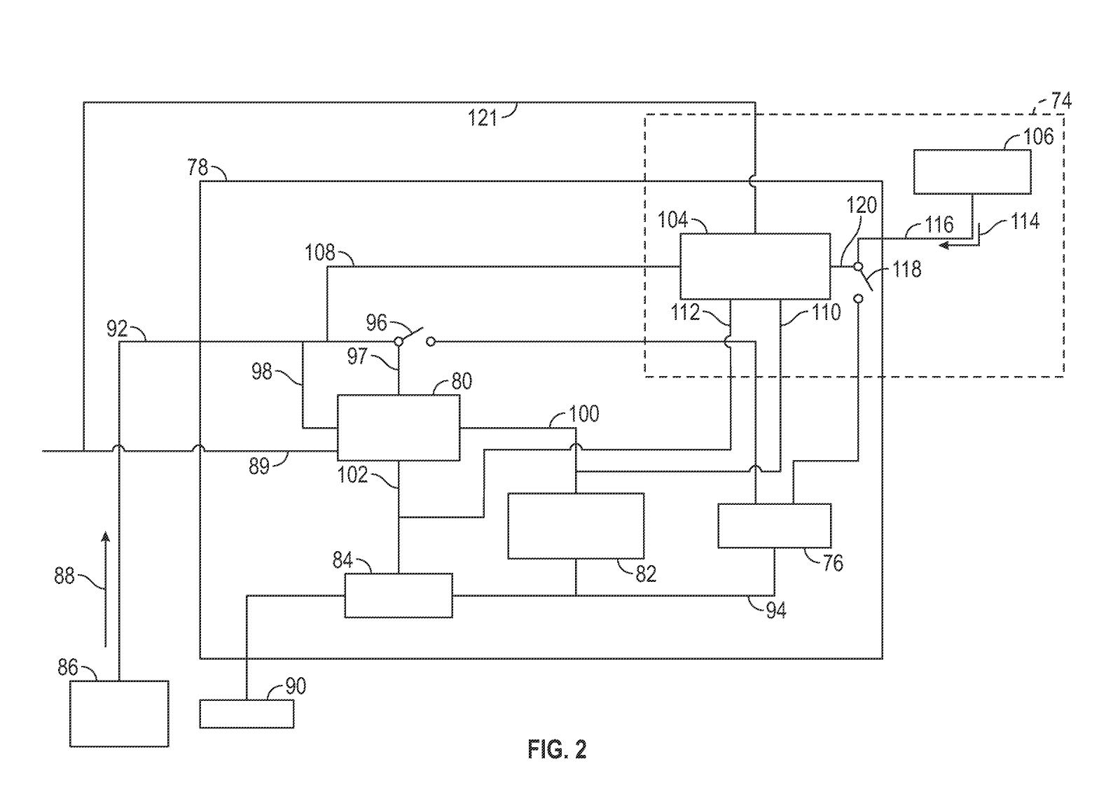

With respect to FIG. 2, a schematic view is presented illustrating a non-limiting example of an arrangement 74 for recharging a rechargeable backup battery 76. Arrangement 74 is configured for use with a telematics unit 78.

Telematics unit 78 may be any suitable type of telematics unit including, but not limited to, telematics unit 24 discussed above with respect to FIG. 1 and/or an aftermarket telematics unit. An exemplary aftermarket telematics unit is disclosed and described in pending U.S. patent application Ser. No. 12/787472 filed on May 26, 2010, and also in U.S. Publication No. 2005/0273211 published on Dec. 8, 2005, each of which is hereby incorporated herein by reference in its entirety. Telematics unit 78 is electrically connected to an electric power source 86, which may comprise an alternator or a vehicle battery. Electric power source 86 is configured to supply telematics unit 78 with an electric current 88. Telematics unit 78 is further connected to ground 90.

In the illustrated example, telematics unit 78 includes rechargeable backup battery 76, a primary charge controller 80, a battery temperature sensor 82, and a current sensor 84. An electric wire 92 delivers electric current 88 to rechargeable backup battery 76 and an electric wire 94 electrically connects rechargeable backup battery 76 to ground 90. A switch 96 is configured to interrupt the flow of electric current 88 from electric power source 86 to rechargeable backup battery 76.

Primary charge controller 80 may comprise any suitable controller, processor, microprocessor, computer, circuit, or other device that is configured to perform algorithms, to execute software applications, to execute sub-routines and/or to be loaded with, and to execute, any other type of computer program. Battery temperature sensor 82 is configured to detect the temperature of rechargeable backup battery 76. Current sensor 84 is configured to detect the magnitude of the current flowing into rechargeable backup battery 76.

Primary charge controller 80 is coupled to electric wire 92 via lead 98 and is configured to detect whether the vehicle in which telematics unit 78 is mounted is in an on state or an off state. In some examples, primary charge controller 80 is configured to determine whether the vehicle is in the on state of the off state by monitoring the voltage of electric wire 92. For example, if primary charge controller 80 detects that the voltage is high (i.e., approximately 12 Volts), primary charge controller 80 will determine that the vehicle is in the on state. Conversely, if the voltage is low (i.e., approximately 0 volts), primary charge controller 80 will determine the vehicle is in the off state. In other examples, primary charge controller 80 may be communicatively coupled with the vehicle bus via wire 89 and may receive a message over the vehicle bus indicating that the vehicle has been placed in the on state or off state.

Primary charge controller 80 is operatively coupled to switch 96 via lead 97 and is further configured to close switch 96 when primary charge controller 80 detects that the vehicle is in the on state, thereby allowing electric current 88 to recharge rechargeable backup battery 76. Primary charge controller 80 is further configured to open switch 96 when primary charge controller 80 detects that the vehicle is in the off state. This action will inhibit undesired drainage of the vehicle's battery.

Primary charge controller 80 is communicatively coupled to battery temperature sensor 82 via lead 100 and is configured to receive information from battery temperature sensor 82 relating to the temperature of rechargeable backup battery 76. In some examples, it is desirable to recharge rechargeable backup battery 76 when rechargeable backup battery 76 is in a temperature range between 0 degrees Celsius and 85 degrees Celsius. This temperature range may vary depending upon the type and design of battery comprising rechargeable backup battery 76. It may be undesirable to recharge rechargeable backup battery 76 when rechargeable backup battery 76 is outside of the above specified temperature range. Accordingly, primary charge controller 80 is configured to open switch 96 when rechargeable backup battery 76 is at a temperature that is above or below the desired temperature range, thereby inhibiting electric current 88 from reaching rechargeable backup battery 76.

Primary charge controller 80 is also communicatively coupled to current sensor 84 via lead 102 and is configured to receive information from current sensor 84 relating to the magnitude of the electric current flowing into rechargeable backup battery 76. In some examples, it is desirable to recharge rechargeable backup battery 76 with an electric current flowing into rechargeable backup battery 76 exceeding 400 milliamps for a limited time of 70 minutes or until a change in battery temp. of dT/dt is reached. While charging rechargeable backup battery 76, a voltage of 5.6 Vdc or rechargeable backup battery temperature above or below desired temp. range will end charging. After 70 minutes or battery change in temperature of dT/dt the primary charge controller reduces the electric current flowing into rechargeable backup battery 76 to 110 milliamps. This is indicative of rechargeable backup battery 76 nearing its capacity to store electric energy. Under such circumstances, it may be desirable to discontinue further charging after 35 minutes or battery temperature reaches 50 C. Accordingly, primary charge controller 80 is configured to open switch 96 thereby inhibiting electric current 88 from reaching rechargeable backup battery 76.

Arrangement 74 includes a secondary charge controller 104 and an electrical device 106. In the illustrated example, a secondary charge controller 104 is included as a component of telematics unit 78. In other examples, secondary charge controller 104 may comprise a component that is separate from telematics unit 78 and which is adapted to couple with a telematics unit 78.

Secondary charge controller may comprise any suitable controller, processor, microprocessor, computer, circuit, or other device that is configured to perform algorithms, to execute software applications, to execute sub-routines and/or to be loaded with, and to execute, any other type of computer program. In the illustrated example, secondary charge controller 104 is coupled to electric wire 92 via lead 108 and is configured to utilize lead 108 to monitor electric wire 92 to determine whether the vehicle is in an on state or an off state. In other examples, lead 108 may couple secondary charge controller 104 to primary charge controller 80. In such examples, primary charge controller 80 may be configured to transmit a message to secondary charge controller 104 indicative of vehicle being in either an on state or off state. In still other examples, secondary charge controller 104 may be communicatively coupled to the vehicle bus via wire 121.

In the illustrated example, secondary charge controller 104 is also coupled with lead 100 via lead 110 and is configured to utilize lead 110 to monitor lead 100 to determine the temperature of rechargeable backup battery 76. In other examples, secondary charge controller 104 may be directly coupled to battery temperature sensor 82 via lead 110. In such examples, secondary charge controller 104 would be configured to monitor battery temperature sensor 82 directly to determine the temperature of rechargeable backup battery 76.

In the illustrated example, secondary charge controller 104 is also coupled with lead 102 via lead 112 and is configured to utilize lead 112 to monitor lead 102 to determine the magnitude of electric current flowing into rechargeable backup battery 76. In other examples, secondary charge controller 104 may be directly coupled to current sensor 84 via lead 112. In such examples, secondary charge controller 104 would be configured to monitor current sensor 84 directly to determine the magnitude of the current flowing into rechargeable backup battery 76.

Electrical device 106 may be any electrical device that is configured to convert light energy into electrical energy. In some examples, electrical device 106 may comprise a photovoltaic cell. In some examples, electrical device 106 may deliver electric power to secondary charge controller 104. In the illustrated example, electrical device 106 has been depicted as a separate component from telematics unit 78. In other examples, electrical device 106 and may be integrated into telematics unit 78. Electrical device 106 may be positioned in the vehicle in any suitable location that permits electrical device 106 to receive sunlight or any other light. For example, electrical device 106 may be positioned on the vehicle's front or rear windshield. In other examples, electrical device 106 may be positioned on any external surface of the vehicle.

Electrical device 106 is configured to deliver an electric current 114 to rechargeable backup battery 76 via an electric wire 116. A switch 118 is positioned between electrical device 106 and rechargeable backup battery 76. When switch 118 is in an open state, electric current 114 is inhibited from reaching rechargeable backup battery 76. Conversely, when switch 116 is in a closed state, electric current 114 is able to reach rechargeable backup battery 76.

Secondary charge controller 104 is operatively coupled to switch 118 via lead 120. When secondary charge controller 104 detects that the vehicle is in an off state, secondary charge controller is configured to close switch 118. When switch 118 is closed, electric current 114 flows into rechargeable backup battery 76. The flow of electric current 114 into rechargeable backup battery 76 allows rechargeable backup battery 76 to recharge while the vehicle is in an off state. When secondary charge controller 104 detects that the vehicle is in an on state, secondary charge controller is configured to open switch 118. When switch 118 is open, electric current 114 is inhibited from flowing into rechargeable backup battery 76.

Secondary charge controller 104 is further configured to open switch 118 to discontinue the recharging of rechargeable backup battery 76 when rechargeable backup battery 76 is at a temperature that falls outside of the temperature range of 0 degrees Celsius to 85 degrees Celsius. Secondary charge controller 104 is further configured to open switch 118 to discontinue further recharging of rechargeable backup battery 76 when the magnitude of the current flowing into rechargeable backup battery 76 falls below 5 milliamps or a rechargeable backup battery voltage of 5.6 Vdc is reached.

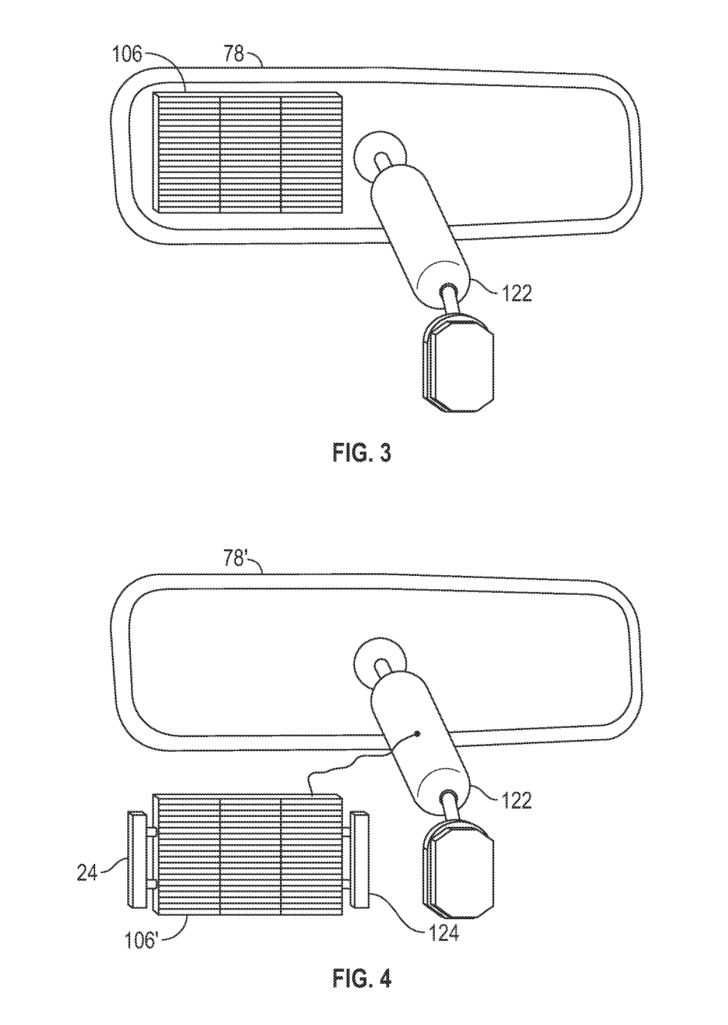

With respect to FIG. 3, a perspective view of telematics unit 78 is presented. In this example, telematics unit 78 takes the form of a rear view mirror. It should be understood that telematics unit 78 is not limited to configurations as a rear view mirror, but rather, may have any other suitable configuration. Electrical device 106 is integrally mounted to a rear portion of telematics unit 78. In the illustrated example, electrical device 106 is configured as a photovoltaic cell. It should be understood, that in other examples, electrical device 78 may comprise any suitable electrical device that is configured to convert light energy into electrical energy.

Telematics unit 78 includes a mounting assembly 122 that is configured to attach telematics unit 78 to an inside portion of a front windshield of the vehicle. When so mounted, electrical device 106 will face the windshield and will therefore be exposed to sunlight energy and/or other light energy that enters the vehicle through the windshield.

With respect to FIG. 4, a perspective view of telematics unit 78′ is presented. Telematics unit 78′ is configured as a rear view mirror and further includes mounting assembly 122 to enable telematics unit 78′ to be mounted to the inside portion of a front windshield of the vehicle. With continuing reference to FIG. 3, unlike electrical device 106 of telematics unit 78, electrical device 106′ of telematics unit 78′ is a separate component from the rear view mirror and is configured to be mounted directly to the inside portion of the front windshield of the vehicle at a location that is spaced apart from the rear view mirror. To facilitate such mounting, electrical device 106′ includes a pair of mounting plates 124 that are treated with an adhesive to facilitate the mounting of electrical device 106′ to the windshield. In other examples, any other suitable mechanism for mounting electrical device 106′ to the windshield may be employed. By separating electrical device 106′ from the rearview mirror, electrical device 106 may be positioned at a location on the windshield of the vehicle that is best suited to intercept light energy passing through the windshield.

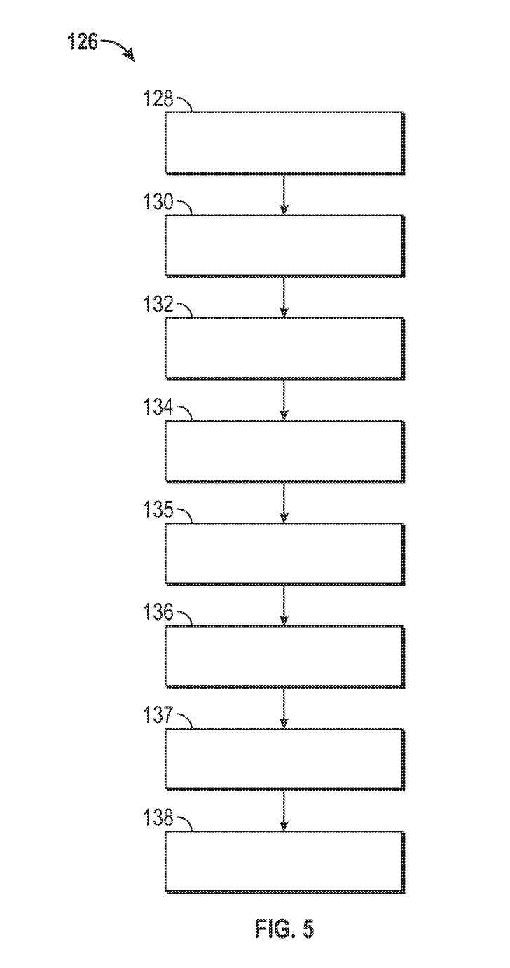

With respect to FIG. 5, an example of a method 126 for recharging a rechargeable backup battery of a telematics unit of a vehicle is illustrated. At block 128, a charging controller detects when the vehicle is in an off state. Once the vehicle is in an off state, at block 130, the charging controller directs an electric current into the rechargeable backup battery from an electrical device that is configured to convert light energy into electrical energy.

At block 132, the temperature of the rechargeable backup battery is sensed with a battery temperature sensor. At block 134, the charging controller inhibits the electric current from flowing into the rechargeable backup battery when the temperature of the rechargeable backup battery falls outside of a predetermined range. In some examples, the predetermined range is between 0 degrees Celsius and 85 degrees Celsius.

At block 135 magnitude of the electric current flowing into the rechargeable backup battery is sensed with a current sensor. At block 136, the charging controller inhibits the electric current from flowing into the rechargeable backup battery when the voltage of the rechargeable backup battery reaches 5.6 Vdc or the magnitude of electric current flowing into the rechargeable backup battery falls below a predetermined magnitude. In some examples, the predetermined magnitude is 5 milliamps.

At block 137, the charging controller detects when the vehicle is in an on state. At block 138, the charging controller inhibits an electric current from the electrical device from flowing into the rechargeable backup battery when the vehicle is in an on state.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An arrangement for recharging a rechargeable backup battery of a telematics unit associated with a vehicle, the arrangement comprising:
an electrical device electrically coupled with the rechargeable backup battery, the electrical device configured to convert light energy into electricity; and
a charge controller configured to direct an electric current flowing from the electrical device into the rechargeable backup battery to recharge the rechargeable backup battery when the vehicle is in an off state.

2. The arrangement of claim 1, wherein the electrical device comprises a photovoltaic cell.

3. The arrangement of claim 1, wherein the electrical device is integrated into the telematics unit.

4. The arrangement of claim 1, wherein the electrical device is separate from the telematics unit.

5. The arrangement of claim 1, the telematics unit further including a battery temperature sensor, wherein the charge controller is communicatively coupled to the battery temperature sensor and is further configured to inhibit the electric current from the electrical device from flowing into the rechargeable backup battery when the battery temperature sensor detects a temperature of the rechargeable backup battery that falls outside of a predetermined temperature range.

6. The arrangement of claim 5, wherein the predetermined temperature range is between approximately 0 degrees Celsius and 85 degrees Celsius

7. The arrangement of claim 1, the telematics unit further including an electric current sensor, wherein the charge controller is communicatively coupled to the electric current sensor and is further configured to inhibit the electric current from the electrical device from flowing into the rechargeable backup battery when the rechargeable back up battery voltage reaches 5.6 Vdc or the electric current sensor detects that the electric current flowing into the rechargeable backup battery falls below a predetermined electric current.

8. The arrangement of claim 7, wherein the predetermined electric current is approximately 5 milliamps.

9. A telematics unit for use with a vehicle, the telematics unit comprising:
a housing;
a rechargeable backup battery disposed within the housing;
a primary charge controller disposed within the housing and configured to direct a first electric current from a primary electric power source into the rechargeable backup battery when the vehicle is in an on state;
an electrical device associated with the housing, the electrical device electrically coupled with the rechargeable backup battery and configured to convert light energy into electricity; and
a secondary charge controller configured to direct a second electric current from the electrical device into the rechargeable backup battery to recharge the rechargeable backup battery when the vehicle is in an off state.

10. The telematics unit of claim 9, wherein the electrical device comprises a photovoltaic cell.

11. The telematics unit of claim 9, wherein the electrical device is integrated into the housing.

12. The telematics unit of claim 9, wherein the electrical device is separate from the housing.

13. The telematics unit of claim 9, further comprising a battery temperature sensor, wherein the secondary charge controller is communicatively coupled to the battery temperature sensor and is further configured to inhibit the second electric current from the electrical device from flowing into the rechargeable backup battery when the battery temperature sensor detects a temperature of the rechargeable backup battery that falls outside of a predetermined temperature range.

14. The telematics unit of claim 13, wherein the predetermined temperature range is between approximately 0 degrees Celsius and 85 degrees Celsius.

15. The telematics unit of claim 9 further comprising an electric current sensor, wherein the secondary charge controller is communicatively coupled to the electric current sensor and is further configured to inhibit the second electric current from the electrical device from flowing into the rechargeable backup battery when the rechargeable back up battery voltage reaches 5.6 Vdc or the electric current sensor detects that a magnitude of the second electric current entering the rechargeable backup battery falls below a predetermined magnitude.

16. The telematics unit of claim 15, wherein the predetermined magnitude is approximately 5 milliamps.

17. A method of recharging a rechargeable backup battery of a telematics unit of a vehicle, the method comprising:
detecting, with a charging controller, that the vehicle is in an off state; and
directing, with the charging controller, an electric current from an electrical device configured to convert light energy into electrical energy to the rechargeable backup battery when the charging controller detects that the vehicle is in the off state.

18. The method of claim 17, further comprising:
detecting, with a battery temperature sensor, a temperature of the rechargeable backup battery; and
inhibiting, with the charging controller, the electric current from the electrical device from flowing into the rechargeable backup battery when the temperature of the rechargeable backup battery falls outside of a predetermined temperature range.

19. The method of claim 17, further comprising:
detecting, with an electric current sensor, a magnitude of electric current flowing into the rechargeable backup battery; and
inhibiting, with the charging controller, the electric current from the electrical device from flowing into the rechargeable backup battery when the electric current sensor detects that the magnitude of electric current flowing into the rechargeable backup battery falls below a predetermined magnitude.

20. The method of claim 17, further comprising:
detecting, with the charging controller, that the vehicle is in an on state; and
inhibiting, with the charging controller, the electric current from the electrical device from flowing into the rechargeable backup battery when the vehicle is in an on state.
